(19) United States
(12) Patent Application Publication
(10) Pub. No.: US 2004/0255880 A1
(43) Pub. Date: Dec. 23, 2004

(54) Linear motion engine

(76) Inventors: Young Hwan Kim, Kyunggi-do (KR); Joo Hoe Kim, Seoul (KR)

Correspondence Address: KING & SCHICKLI, PLLC, 247 NORTH BROADWAY, LEXINGTON, KY, 40507, US

(21) Appl. No.: 10/782,632

(22) Filed: Feb. 19, 2004

(30) Foreign Application Priority Data
Feb. 20, 2003 (KR) 10-2003-0010762

(51) Int. Cl. F02B 75/18; F02B 75/22

(52) U.S. Cl. 123/55.5; 123/55.7

(57) ABSTRACT

The present invention relates to a linear motion engine, wherein four cylinders are arranged in two laterally opposing rows with each of their respective piston rods sharing common linkage to a slider located in midway between the two-cylinder rows and connected to the eccentric crank shafts of a flywheel; and whereby each cylinder piston goes through an alternate linear motion comprising four steps of strokes of intake, compression, combustion and exhaust, constituting an engine unit capable of delivering power output through linear motion of the slider itself, subsequently contributing to an elimination of power loss from circular motion changeover and enabling to produce a compact engine suitable for work machines operated by linear motion.

### TECHNICAL FIELD

The present invention relates to a linear motion engine, in particular to an engine that exclusively undertakes a linear motion operation for work machines operated by linear motion.

### BACKGROUND OF THE INVENTION

Various reciprocating work machines such as piston type compressors, presses, vibrators, etc. are designed to work via linear motion. However, these linear-motion work machines require installation of a changeover equipment such as a crank that converts circular motion to linear motion. Conventional relationship between a work machine being run in linear motion and its use of engine power is that, in case of an engine, the linear motion of a piston is converted to circular motion by a crank prior to power output delivery and when the driving wheel (crank) of a work machine is rotated by the delivered power, this rotational motion is converted again to linear motion by the crank, causing a compressive piston to operate in a linear motion for compression of the fluid within. Thus, the operating mechanism of changeover from an engine to a linear motion-driven work machine follows the steps of linear motion-circular motion (of engine)-circular motion-linear motion (of work machine), resulting in considerable power loss in the course of changeovers and diminished engine power utility rate on the part of a work machine such as a compressor.

Since the power of every type of conventional engines is being delivered via circular motion, some changeover means for converting circular motion to linear motion becomes necessary in order to activate a linear motion type machine.

Accordingly, a linear motion type work machine tends to become complicated and voluminous in terms of mechanical structure, inconvenient in terms of handling and maintenance and expensive in terms of production cost.

### SUMMARY OF THE INVENTION

An objective of the present invention is to provide an engine capable of delivering power via linear motion alone.

Another objective of the invention is to provide a linear motion engine, wherewith engine power utility rate is improved through direct linkage of an engine capable of power output via linear motion to a linear motion work machine like a piston-driven compressor, making it possible to simplify the mechanical structure and reduce the size of the machine with the omission of the circular-linear motion changeover device, bringing forth improved performance as well as reduced production cost.

Another objective of the invention is to make the engine available for use with various industrial presses, pumps, hammers, vibrators and other machines of linear motion.

The present invention of a new linear motion engine is developed in consideration of the identical nature of the four-step strokes of the pistons of an engine in the combustion stroke of fuel and the exhaust stroke and of the intake and compression strokes of fuel. Specifically, four (but not limited to four) cylinders suitable for performing four strokes in a sequential order are arranged in laterally opposing two rows on the main body. In midway between the opposing two rows stated above, a slider is provided on a guide rail to allow for lateral movement.

Further, the construction of the linear motion engine of the present invention is realized by the installation of a flywheel on one side of the main body by an axis and connecting the eccentric shaft of the crank of the flywheel to a longitudinal sliding slot provided on the slider above so that the transverse track of the crank confines the stroke lengths of both the top dead center and the bottom dead center of the piston while the flywheel can be utilized to start the engine.

In this engine of the present invention, the unique arrangement of cylinders and the operation of a slider to which piston rods from both sides are commonly connected and of a crank which confines the stroke lengths of the slider cause the respective pistons of individual cylinders move alternately in linear motion through the operating phases of fuel intake, compression, combustion and exhaust strokes, leading to the left and right linear motion of the slider connected with pistons.

The power output of the linear motion engine of the present invention is nothing other than the linear movement of the slider itself. The flywheel is used at the starting of the engine. And, equipped in each cylinder head of the engine are a spark plug, fuel intake manifold, exhaust manifold, fuel valve and exhaust valve, which are synchronized to engine's individual strokes for timely opening and closing of fuel valves and exhaust valves, and the four strokes of the engine, namely, the ignition by spark plugs, the intake, compression, combustion and exhaust of fuel are carried out in the same manner as in those of ordinary engines.

To be specific, when fuel mixed with air (hereinafter referred to “fuel”) ignites with the aid of the spark plug, the piston is forced by the combustion to make a linear motion toward the bottom dead center while the slider linked to the piston rod of cylinder 1 is moved to the other direction on the guide rail. The action causes the piston of cylinder 2 to go through the fuel compression stroke while the piston of cylinder 3 is forced by the slider toward the bottom dead center to go through the fuel intake stroke, and the piston of cylinder 4 goes through exhaust stroke to emit the combustion gases from previous stroke.

As the piston of cylinder 2 reaches the top dead center, the fuel is ignited by spark plug and the resultant combustion forces the piston of cylinder 2 toward the bottom dead center in linear motion while the slider is moved to one side on the guide rail. The action causes the piston on cylinder 1 to perform the exhaust stroke to emit combustion gases while the piston on cylinder 3 is forced through the fuel compression stroke and the piston on cylinder 4 is forced through the fuel intake stroke.

When the piston on cylinder 3 reaches the top dead center, the fuel is ignited by the spark plug performing combustion stroke, which in turn forces the piston on cylinder 3 to make a linear movement toward bottom dead center, causing the slider to move to the other side on the guide rail. The action of the slider causes the piston on cylinder 1 to perform the fuel intake stroke while the piston of cylinder 2 performs the exhaust stroke to emit combustion gases and the piston on cylinder 4 performs the fuel compression stroke.

As the piston on cylinder 4 reaches the top dead center, the fuel is ignited by the spark plug to make a combustion and the combustion causes the piston on cylinder 4 to make a linear movement toward the bottom dead center while the slider is moved to one side on the guide rail. This very action of the slider causes the fuel taken in to be compressed by the piston on cylinder 1, while the piston on cylinder 2 performs the fuel intake stroke and the piston on cylinder 3 performs exhaust stroke on combustion gases.

As the cyclic processes in which the spark plugs ignite in a timely manner and the fuel valves and exhaust valves are opened and closed appropriately satisfying the requirements of individual strokes is identical with those of ordinary engines, a separate description is omitted here.

Thus, each time the four stroke processes of compression, combustion, exhaust and intake take place in the order of cylinder 1, cylinder 2, cylinder 3 and cylinder 4, the slider makes linear movement either to the right or left on the guide rail. This very lateral reciprocation of the slider is the source of power output.

While the slider is reciprocating, a cross sliding function combining the transverse movement of the slider and the lengthwise movement of the crank's eccentric shaft within a lengthwise sliding slot causes the flywheel to rotate. The effect of rotational inertia allows an easy directional turnabout of the slider's linear movement. As the spark plug ignites fuel at the moment the piston passes the top dead center of individual cylinders, the engine power output can be increased and the vibration level of the engine can be lowered. And, as the lateral stroke of the slider is confined within the permissible limit by the operation of the eccentric shaft of the crank, the travel of pistons is restricted from exceeding both the bottom and top dead centers.

Because the reciprocating motion of the slider in this engine of the present invention produces power output, no crank or similar device is required for changeover of circular motion.

Accordingly, by directly linking the piston rod of a reciprocating work machine such as a compressor to the slider of the engine of the present invention, the compressor can be operated directly with the reciprocating movement of its piston.

As the reciprocating engine of the present invention eliminates the need for the installation of a separate changeover means of circular motion, the structure of the engine becomes compact and simplified proportionately, contributing to lower production cost. Also, handling becomes easier while maintenance is more convenient.

Further, an application of the linear motion engine of the present invention to various work machines run via linear motion can eliminate those devices designed to convert the circular motion to linear motion from various work machines. By directly linking the linear motion engine of the present invention to these work machines, a smaller machine unit can be achieved with more engine power output.

In addition, prevention of any energy loss associated with the changeover of the linear motion of a cranking device to a circular motion contributes to an improved utility rate of the engine on a linear motion machine.

The ability to simplify the structure and reduce the size of the linear motion engine of the present invention and the accompanying higher power output allows for a wide range of useful application not only to the compressor sector but also to the linear motion machines of various industries.

The following description shows and describes a preferred embodiment of this invention simply by way of illustration of one of the modes best suited to carry out the invention. As it will be realized, the invention is capable of other different embodiments, and its several details are capable of modifications in various, obvious aspects all without departing from the invention. Accordingly, the drawings and descriptions will be regarded as illustrative in nature and not as restrictive.

### Brief Decription of the Drawings

The accompanying drawings incorporated in and forming a part of the specification, illustrate several aspects of the present invention, and together with the description serve to explain the principles of the invention. In the drawings:

FIG. 1 is a sectional side view showing major components of the present invention;

FIG. 2 is a sectional plane view of the major components of the present invention;

FIG. 3 is a plane view of the present invention;

FIG. 4 is a sectional view of the engine to which a compressor is connected; and

FIG. 5 shows operations of the engine strokes of the present invention, namely: ‘A’ shows a combustion stroke of Cylinder 1; ‘B’ shows a combustion stroke of Cylinder 2; ‘C’ shows a combustion stroke of Cylinder 3; and ‘D’ shows combustion stroke of Cylinder 4.

Reference will now be made in detail to the present preferred embodiment of the invention, an example of which is illustrated in the accompanying drawings.

[Symbols Used on Major Parts in the Drawings]

1: Body 2: Cylinder 2p: Piston 2c: Piston rod 3: Slider 3h: Sliding slot 4: Guide rail 5: Flywheel 5c: Crank 5s: Eccentric shaft

### DETAILED DESCRIPTION OF THE PREFERRED EMBODIMENT

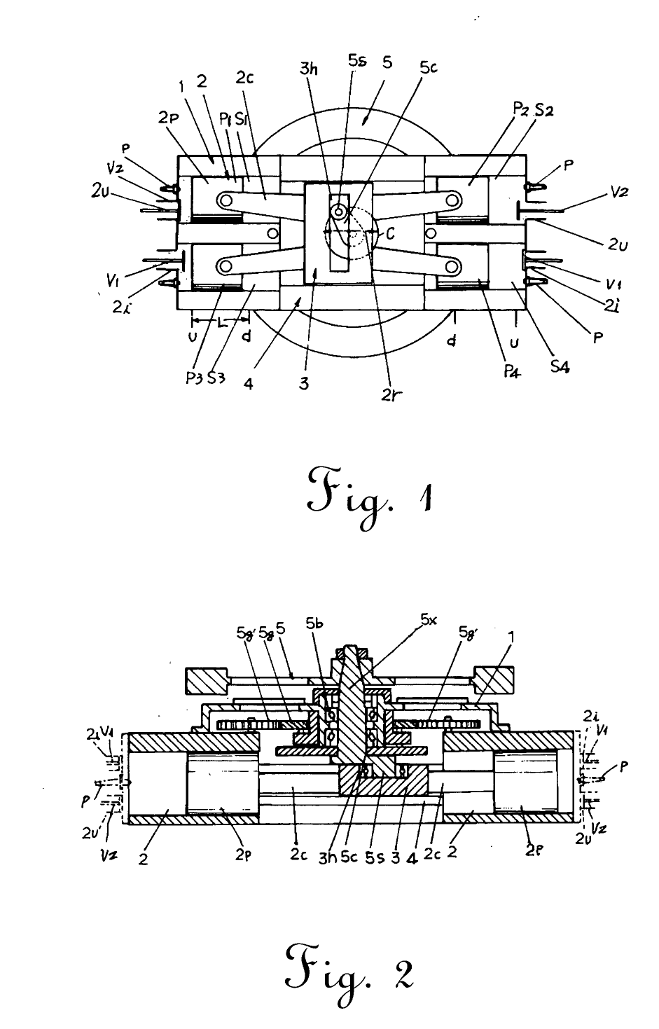

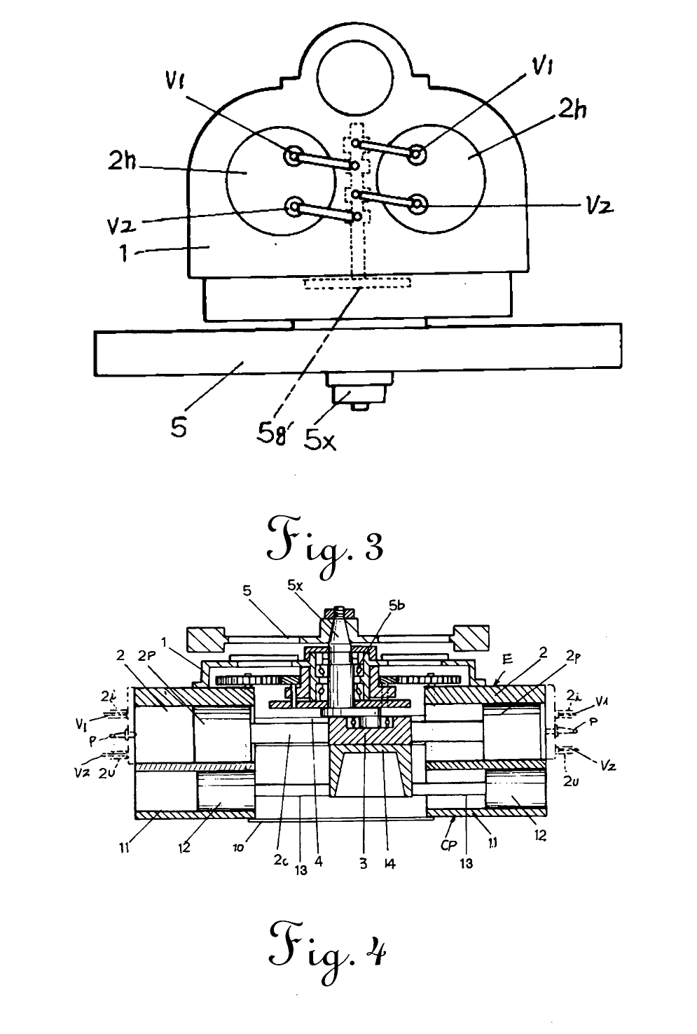

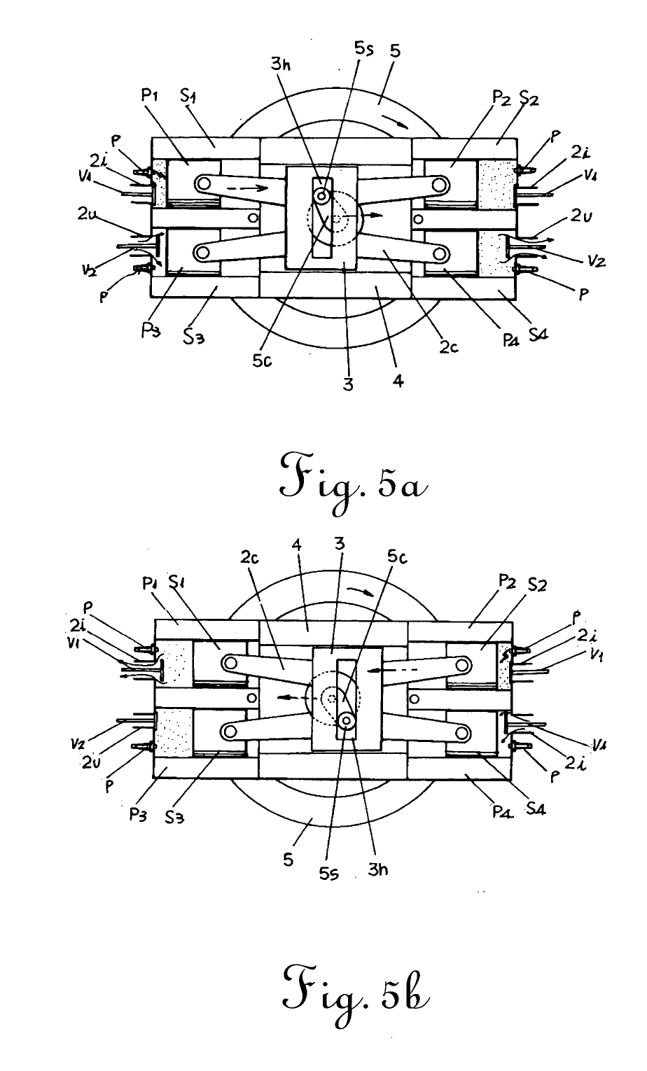

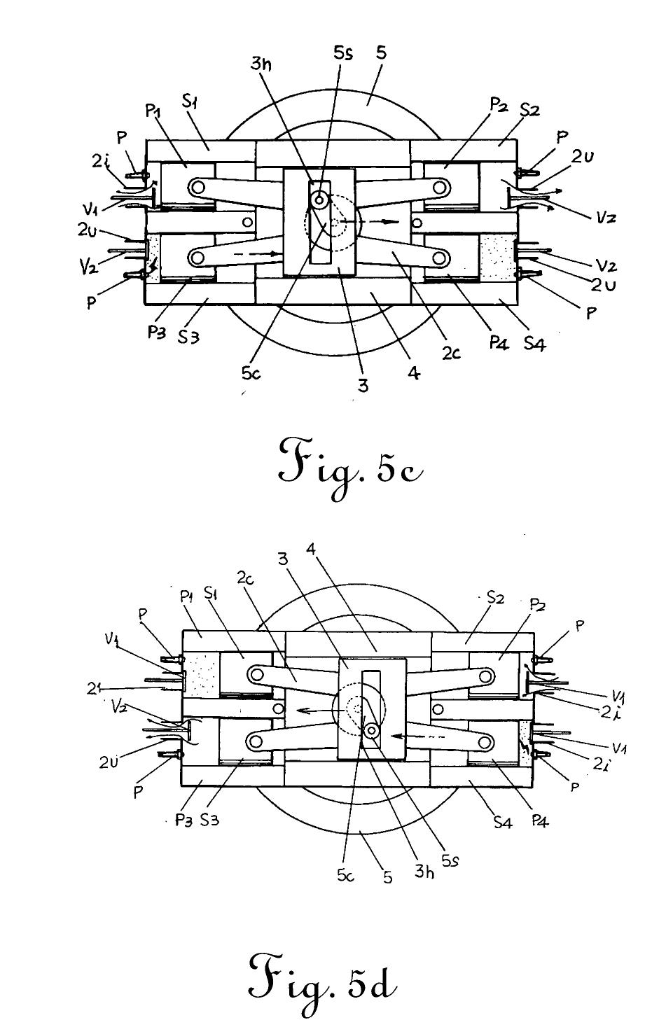

A detailed description of one embodiment of the present invention follows with reference to the attached drawings: FIG. 1 is a sectional side view that roughly shows the engine construction of the present invention; FIG. 2 shows a sectional plane view of the same; and FIG. 3 is a plane view and FIG. 4a sectional view of an example where the engine of the invention is directly linked to a piston type compressor.

In FIG. 1, a plural number of cylinders 1 (four cylinders on the drawing) are arranged in pairs in two opposing rows on the left and right. That is, respectively, a first cylinder S1, and a third cylinder S3, are arranged side by side as a pair in the opposing direction from the pair of a second cylinder S2 and a fourth cylinder S4, which are also arranged side by side. Situated substantially midway between these two rows of cylinder pairs is a slider 3 which moves transversely left and right on or along a guide rail 4 when the engine is in operation.

Commonly connected to the slider 3 are rods 2c of pistons 2p within each cylinder 1, namely, a first piston P1, a second piston P2, a third piston P3 and a fourth piston P4. Thus, when the pistons P1 and P3 of the left row cylinders S1 and S3 in the drawing move to the right hand bottom dead center (d), the pistons P2 and P4 of the right row cylinders S2 and S4 connected to the slider 3 move toward the top dead center (u), and, conversely, if the pistons of the right row cylinders move toward the left hand bottom dead center (d), the pistons of the left row move toward the top dead centers (u) of the left row cylinders in repeated cycles.

Thus, when the cylinders on one row undertake the strokes of compression and exhaust simultaneously, the cylinders on the other row undertake the strokes of intake and compression simultaneously.

Further, a crank 5c that works to limit the stroke length of the slider 3 is installed on a rotating shaft 5x of a flywheel 5 (see FIG. 2) rotatably fixed with bearings 5b on one side of a main body 1 and an eccentric shaft 5s of the crank 5c is linked to the slider 3 in such a manner as to allow its free vertical travel within a lengthwise sliding slot 3h. A circumference 2r of the rotational track of the crank's eccentric shaft 5s is equal to the stroke length (L) of each piston 2p shown above and the slider 3. Accordingly, the crank 5c confines the pistons 2p from traveling beyond the top and bottom dead centers (u) and (d) of the cylinders.

A fuel valve V1 and an exhaust valve V2 are equipped on the fuel inlet 2i and outlet 2u arranged on each cylinder head 2h as shown in FIG. 3. These valves are designed to be activated in synchronization with the piston's stroke by a suitable device not shown in the drawing.

The fuel valve V1 and the exhaust valve V2 can be opened and closed using timing gear 5g, 5g′ marked on the rotating shaft 5x of the flywheel 5, as shown in FIG. 2 and FIG. 3. However, as this is not a part of the gist of the present invention, it may be assumed that this works in the same manner as in ordinary engines.

The embodiment of the present invention of the above construction works in the following manner.

(The Combustion Stroke of Cylinder S1)

As shown in FIG. 5a, as the fuel compressed in a previous stroke burns with the ignition by the spark plug P with the fuel valve V1 and the exhaust valve V2 of the cylinder closed, the combustion causes the piston P1 to move right, as viewed on the drawing, toward the bottom dead center (d) and subsequently the slider 3 moves to the right, as viewed on the drawing, on the guide rail 4. By the sliding of the slider 3, piston P2 of cylinder S2, generates an expansion stroke of the fuel previously taken in cylinder S2 by a compression operation. The piston P3 of cylinder S3 undertakes a fuel intake stroke by taking in the fuel through the fuel inlet 2i whose valve V1 is open by suction operation. The piston P4 of cylinder S4 undertakes an exhaust stroke to exhaust the combustion gases from previous stroke through the outlet 2u whose exhaust valve V2 is open by a compression operation.

(The Combustion Stroke of Cylinder S2)

As shown on FIG. 5B, when the compressed fuel burns at the ignition by the spark plug P of the cylinder S2, the piston P2 of the cylinder S2 moves left, as viewed in the drawing, toward the bottom dead center (d), to subsequently cause the slider 3 to move to the left, as viewed in the drawing, on the guide rail 4. With this movement of the slider 3, the piston P1 of cylinder S1 undertakes an exhaust stroke with a compression operation to exhaust the combustion gases produced from a previous stroke through the outlet 2u by an open exhaust valve V1. The piston P3 of cylinder S3 goes through the compression stroke to compress the fuel taken in from the previous stroke with the fuel valve V1 and the exhaust valve V2 closed subsequent to a compression operation. The piston P4 of cylinder S4 undertakes the intake stroke in which fuel is taken in through the fuel inlet 2i whose valve is open subsequent to a suction operation.

(The Combustion Stroke of Cylinder S3)

As illustrated in FIG. 5C, when the piston P3 of cylinder S3 reaches the top dead center (u), the compressed fuel burns with the ignition by the spark plug P and the combustion causes the piston P3 to move right, as viewed in the drawing, toward the bottom dead center (d), moving the slider 3 to the right, as viewed in the drawing, on the guide rail 4. This movement is identical to that of the combustion stroke of cylinder S1. This movement of the slider 3 causes the piston P1 of cylinder S1 to go through the intake stroke operation in which fuel is taken in through the fuel inlet 2i whose valve V1 is open by an intake operation. The piston P3 of cylinder S2 goes through the exhaust stroke in which the combustion gases from the previous combustion stroke are exhausted through the outlet 2u whose valve V2 is open subsequent to a compression operation. The piston P4 of cylinder S4 performs the compression stroke with its fuel valve V1 and exhaust valve V2 closed by a compression operation.

(The Combustion Stroke of Cylinder 4)

As the piston P4 of cylinder S4 reaches the top dead center (u), the compressed fuel burns with the ignition by a spark plug P and the combustion forces the piston P4 toward the bottom dead center (d) while the slider 3 moves to the right, as viewed in the drawing, on the guide rail 4. This movement of the slider 3 causes the piston P1 of cylinder S1 to go through the compression stroke in which the fuel taken in from previous stroke is compressed. The piston P2 of cylinder S2 goes through the intake stroke in which fuel is taken in through the fuel inlet 2i whose fuel valve V2 is open by the intake operation. The piston P3 of cylinder S3 goes through the exhaust stroke in which the combustion gases from the previous combustion operation are exhausted through outlet 2u whose exhaust valve V2 is open subsequent to a compressive operation. As the ignition time, the opening and closing time of each fuel valve V1 and exhaust valve V2 and their operation are made in the manner as in known arts of ordinary engines, no separate description is presented here. Thus, while the pistons P1 and P3 of the left row and the pistons P2 and P4 of the right row are always made to move in the same direction by the left-right movement of the slider 3, the pistons' proceeding directions of the left row and the right row to reach the top dead center (u) and the bottom dead center (d) are just in the opposite.

Further, by the transverse movement of the slider 3, the eccentric shaft 5s of the crank 5c connected to the slider slot 3h goes through a cross sliding movement wherein the lengthwise and transverse directions alternate and the movement of crank 5c is converted to circular motion, rotating the flywheel rotating. As the rotational inertia of the flywheel 5 helps the crank 5c facilitate the directional turnabout of the slider 3 at both the top dead center (u) and the bottom dead center (d) for each piston, allowing the combustion stroke to take place at the moment the directional changeover is consummated, the engine power is increased with no noticeable vibration and the linear motion of the slider is kept smooth. In addition, the level of engine stability is highly enhanced as the stroke length (L) of the piston 2 of every cylinder 1 is restricted within a certain limit by the eccentric shaft 5s of the crank 5c.

Since a linear motion of the slider 3 on its guide rail 4 can be realized through the reciprocating movement of the cylinder pistons of the engine of the present invention in the course of four-stroke processes by the cylinders of the present invention, this unique type reciprocating engine can be applied to various work machines driven by reciprocating operation without circular movement.

### EXAMPLE

FIG. 4 is an illustration of the application example wherein the engine E of the present invention is combined with a piston driven compressor CP.

For the compressor CP, cylinders 11 are arranged on the left and right sides in opposing sides of the body, with a slider 14 situated substantially midway between the left and right side cylinders 11. The piston rods 13 of the cylinders 11 on both sides are commonly linked to both sides of the slider 14. As the slider 14 moves left or right, the pistons 12 compress fluid within the cylinders 11.

In this example, the slider 14 of the compressor CP is incorporated into the slider 3 of the engine 4 of the present invention via a suitable linkage.

With the activation of the engine E of the present invention, the cyclic processes of the piston 2p of the cylinder 2 of intake, compression, combustion and exhaust strokes are carried out leading to reciprocating linear motion of the slider 3 producing power output. With this power output, the lateral motions of the slider 14 of the compressor CP takes place. This, in turn, causes the pistons 12 on both sides to alternatingly compress fluid within the cylinders 11.

Though illustration is given to the compressor in this example, the engine of the present invention can be applied to such industrial machines as presses, hammers, vibrators and various other work machines driven by reciprocating motion.

The effect of the present invention is that a linear motion engine of new concept departing from the conventional concept of circular motion engine can be provided through an arrangement wherein two rows of a plural number of cylinders in pairs are laid out in opposing rows with their individual piston rods connected commonly to a slider located in midway between these two rows so that the operation of the engine's four stroke cycle causes the slider to make linear motions left and right.

Since the engine of the present invention realizes power output directly from a piston's linear motion, thus precluding a need for a device to convert the linear motion of the pistons to circular motion, various work machines driven by the linear motion of an engine can be run without a means to convert the circular motion of engine to linear motion by directly connecting the engine of the present invention to a work machine in a simple manner.

Furthermore, by doing away with a device converting linear motion to circular motion, the engine can be made more of a compact size producing greater power output.

Further, ommission of a changeover device to convert circular motion to linear motion from a work machine allows a decrease in the size of a work machine as well as a structural simplification of the engine, contributing to lower production cost and the facility of carrying, handling and maintenance.

Also, the present invention can be applied more effectively to various work machines of a wide range of industries operated with linear reciprocating motion.

The foregoing description of a preferred embodiment of the invention has not been presented to be exhaustive or to limit the invention to the precise form disclosed. Obvious modifications or variations are possible in light of the above teachings. The present embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A linear motion engine comprising:
a plural number of engine cylinders in pairs laid out in two opposing rows of left and right;
a slider to which each of the rods of the pistons of cylinders shares a common linkage, wherein the slider being forced to slide left and right on a guide rail by the operation of the pistons, said guide rail being arranged substantially midway between the two cylinder rows; and
a flywheel which restricts the stroke length of pistons at each stroke via the linkage of a crank's eccentric shaft to a lengthwise sliding slot of the slider and assists the directional changeover of the slider's motion;
wherein said engine produces power output by the strokes of intake, compression, combustion, and exhaust.

2. The linear motion engine according to claim 1, wherein the each stroke length of the pistons in cylinders equals to the scope of the rotation track of the eccentric shaft of the crank linked to the lengthwise sliding slot of the slider.
